(19) United States
(12) Patent Application Publication
(10) Pub. No.: US 2026/0036093 A1
(43) Pub. Date: Feb. 5, 2026

(54) SYSTEM AND METHOD FOR DELIVERING FUEL TO A GAS TURBINE ENGINE

(71) Applicant: Solar Turbines Incorporated, San Diego, CA (US)

(72) Inventors: James Jonathan Underwood, Chula Vista, CA (US); John Stuart Bowen, San Diego, CA (US); Javier Viruete, Chula Vista, CA (US); Manning Harry Clarke, Tapping (AU)

(73) Assignee: Solar Turbines Incorporated, San Diego, CA (US)

(21) Appl. No.: 18/792,598

(22) Filed: Aug. 2, 2024

(51) Int. Cl. F02C 9/40; F02C 3/22; F02C 9/28

(52) U.S. Cl. CPC F02C 9/40; F02C 3/22; F02C 9/28

(57) ABSTRACT

A system for delivering a fuel to a gas turbine engine, having a combustor defining first zones (located proximal to the ignition source of the gas turbine engine) and second zones (located distal from the ignition source), and a plurality of injectors circumferentially arranged about the combustor, is disclosed. The system includes a start fuel circuit and a main fuel circuit. The start fuel circuit is fluidly coupled to first injectors of the plurality of injectors to facilitate injection of a first quantity of the fuel by the first injectors into the first zones upon activation of the ignition source. The main fuel circuit is fluidly coupled to second injectors of the plurality of injectors to facilitate injection of a second quantity of the fuel by the second injectors into the second zones in response to a light-off of the first quantity of the fuel.

### TECHNICAL FIELD

The present disclosure relates to a system and method for delivering fuel to a gas turbine engine. More particularly, the present disclosure relates to a system and method for delivering an alternative fuel to a gas turbine engine.

### BACKGROUND

Gas turbine engines are used for generating power in a variety of applications including land-based electrical power generating plants. A gas turbine engine produces power by extracting energy from a flow of hot gas produced by combustion of fuel, conventionally, natural gas, and air in a combustor of the gas turbine engine. These hot gases are directed over rotatable blades to produce mechanical power before being released, via an exhaust, into the atmosphere.

There is a rising interest towards using alternative fuels other than conventional fuels (like natural gas) to power the gas turbine engines. Examples of these alternative fuels may include, but not limited to, hydrogen-based fuels and hydrocarbon-based fuels. However, certain properties (e.g., heating capacity, lower flammability limit, etc.) of these alternative fuels may introduce safety risks such as heightened chances of deflagration (or detonation) in the exhaust, particularly, when delivering these alternative fuels during the starting phase of the gas turbine engine.

U.S. Pat. No. 11,306,661 discloses a combustor nozzle apparatus of a gas turbine engine. The combustor nozzle apparatus includes a first circuit to transport a blend of hydrogen gas, inert gas, and/or other combustible gas from a supply to a gas turbine combustor, the blend of hydrogen gas, inert gas, and/or other combustible gas including between 100% hydrogen gas, 100% inert gas, or 100% other combustible gas, a second circuit to transport water from the supply to the gas turbine combustor, and a nozzle tip. The nozzle tip includes a first outlet in connection with the second circuit to provide the water to the gas turbine combustor, and a second outlet in connection with the first circuit. The second outlet is concentrically positioned within the first outlet to provide the blend of hydrogen gas, inert gas, and/or other combustible gas to the gas turbine combustor.

### SUMMARY

In one aspect, the disclosure relates to a system for delivering a fuel to a gas turbine engine. The gas turbine engine includes a combustor and a plurality of injectors circumferentially arranged about the combustor. The system includes a start fuel circuit and a main fuel circuit. The start fuel circuit is configured to be fluidly coupled to one or more first injectors of the plurality of injectors to facilitate injection of a first quantity of the fuel by the one or more first injectors into one or more first zones of the combustor upon activation of an ignition source of the gas turbine engine. The main fuel circuit is configured to be fluidly coupled to one or more second injectors of the plurality of injectors to facilitate injection of a second quantity of the fuel by the one or more second injectors into one or more second zones of the combustor in response to a light-off of the first quantity of the fuel. The one or more first zones are located relatively proximal to the ignition source and the one or more second zones are located relatively distal from the ignition source.

In another aspect, the disclosure relates to a gas turbine engine. The gas turbine engine includes a combustor, an ignition source, and a plurality of injectors. The combustor defines one or more first zones and one or more second zones. The ignition source is configured to initiate a start-up sequence of the gas turbine engine. The injectors are circumferentially arranged about the combustor. The injectors include one or more first injectors and one or more second injectors. Further, the gas turbine engine includes a system for delivering fuel. The system includes a start fuel circuit and a main fuel circuit. The start fuel circuit is configured to be fluidly coupled to the one or more first injectors to facilitate injection of a first quantity of the fuel by the one or more first injectors into the one or more first zones upon activation of the ignition source. The main fuel circuit is configured to be fluidly coupled to the one or more second injectors to facilitate injection of a second quantity of the fuel by the one or more second injectors into the one or more second zones in response to a light-off of the first quantity of the fuel. The one or more first zones are located relatively proximal to the ignition source and the one or more second zones are located relatively distal from the ignition source.

In yet another aspect, the disclosure relates to a method for delivering a fuel to a gas turbine engine. The gas turbine engine includes a combustor and a plurality of injectors circumferentially arranged about the combustor. The method includes fluidly coupling a start fuel circuit to one or more first injectors of the plurality of injectors. The start fuel circuit is configured to facilitate injection of a first quantity of the fuel by the one or more first injectors into one or more first zones of the combustor upon activation of an ignition source of the gas turbine engine. Also, the method includes fluidly coupling a main fuel circuit to one or more second injectors of the plurality of injectors. The main fuel circuit is configured to facilitate injection of a second quantity of the fuel by the one or more second injectors into one or more second zones of the combustor in response to a light-off of the first quantity of the fuel. The one or more first zones are located relatively proximal to the ignition source and the one or more second zones are located relatively distal from the ignition source.

### BRIEF DESCRIPTION OF THE DRAWINGS

FIG. 1 illustrates a schematic diagram of an example gas turbine engine showing a combustor and injectors arranged circumferentially about the combustor, in accordance with an embodiment of the present disclosure;

FIG. 2 is a perspective view of the combustor and an example system arranged with respect to the combustor for communicating fuel to the injectors, in accordance with an embodiment of the present disclosure;

FIG. 3 illustrates a schematic diagram of the example system, in accordance with an embodiment of the present disclosure; and

FIG. 4 is a flowchart illustrating a method for delivering fuel to the example gas turbine engine, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

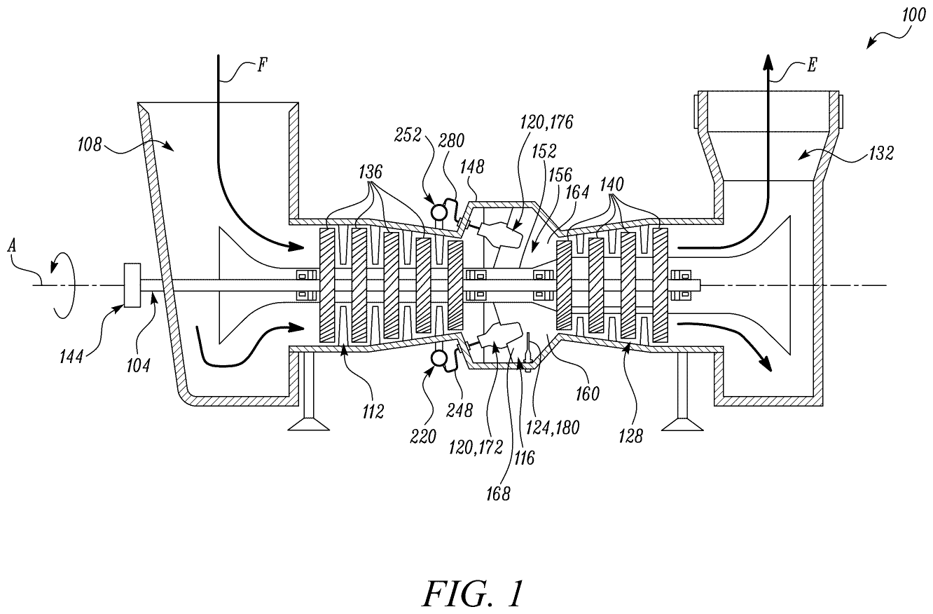

Referring to FIG. 1, an example gas turbine engine 100 is shown. The gas turbine engine 100 may be provided at locations, for example, where supplementary electrical power may be needed, at times of peak demand or brownout in a distribution grid or network, in an emergency or other problem in the distribution grid, or other type of events. The gas turbine engine 100 may be configured to power a generator (not shown) (e.g., via a shaft 104), typically by combusting fuels, such as a hydrogen-based fuels or a hydrocarbon-based fuels.

The gas turbine engine 100 may include an inlet passage 108, a compressor 112, a combustor 116, injectors 120, an ignition source 124, a turbine 128, and an exhaust passage 132. The inlet passage 108 may direct working fluid F (e.g., ambient air) towards the compressor 112. The compressor 112 may be in fluid communication with the inlet passage 108 to receive the working fluid F from the inlet passage 108. The compressor 112, via compressor rotor assemblies 136 mounted on the shaft 104, may compress the working fluid F passing therethrough to generate a compressed working fluid to be supplied to the combustor 116.

The combustor 116 may be in fluid communication with the compressor 112 to receive the compressed working fluid from the compressor 112. The combustor 116 may facilitate mixing the compressed working fluid with fuel (injected via the injectors 120) and igniting the mixture of the compressed working fluid and the fuel (e.g., via the ignition source 124) to generate combustion gases at high pressure and temperature. The combustor 116, the injectors 120, and the ignition source 124 will be discussed in more detail in the following paragraphs.

The turbine 128 may be in fluid communication with the combustor 116 to receive the combustion gases released from the combustor 116 and allow the combustion gases to flow through its turbine rotor assemblies 140 to drive the turbine rotor assemblies 140, thereby causing the shaft 104 to rotate and generate motive power (i.e., mechanical power) to be transmitted to the generator (not shown), for example, via a coupling 144 connecting the shaft 104 to an input shaft (not shown) of the generator.

The exhaust passage 132 may be in fluid communication with the turbine 128 to receive a flow of the combustion gases exhausted (hereinafter referred to as “exhaust gas flow E”) from the turbine 128. Also, the exhaust passage 132 may be configured to direct the exhaust gas flow E received from the turbine 128 either towards the outside environment or towards one or more exhaust treatment units located downstream of the exhaust passage 132.

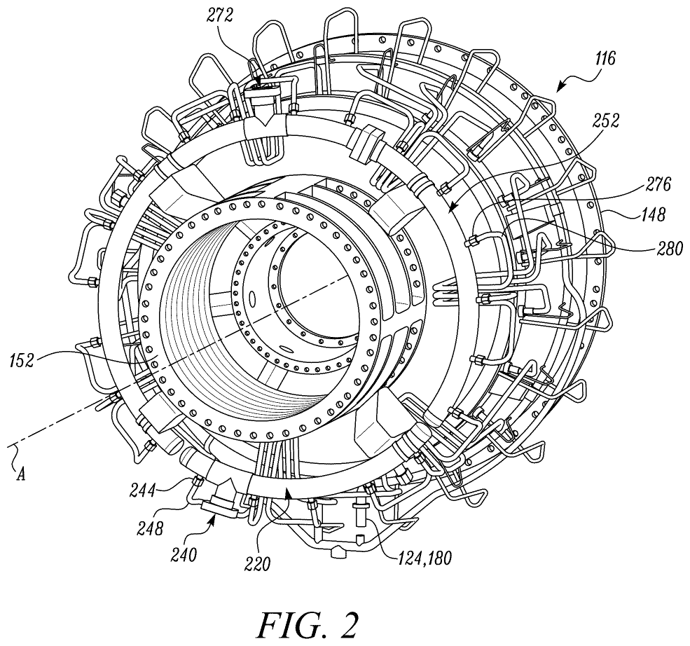

Referring to FIGS. 1 and 2, the combustor 116 is now discussed. The combustor 116 may include a combustor casing 148 and an inner bearing housing 152. The combustor casing 148 and the inner bearing housing 152 may be concentric clamshell casings forming a generally annular cavity 156 therebetween and extending from the compressor 112 to the turbine 128. The combustor casing 148 and the inner bearing housing 152 may be joined together, for example, by struts (not shown).

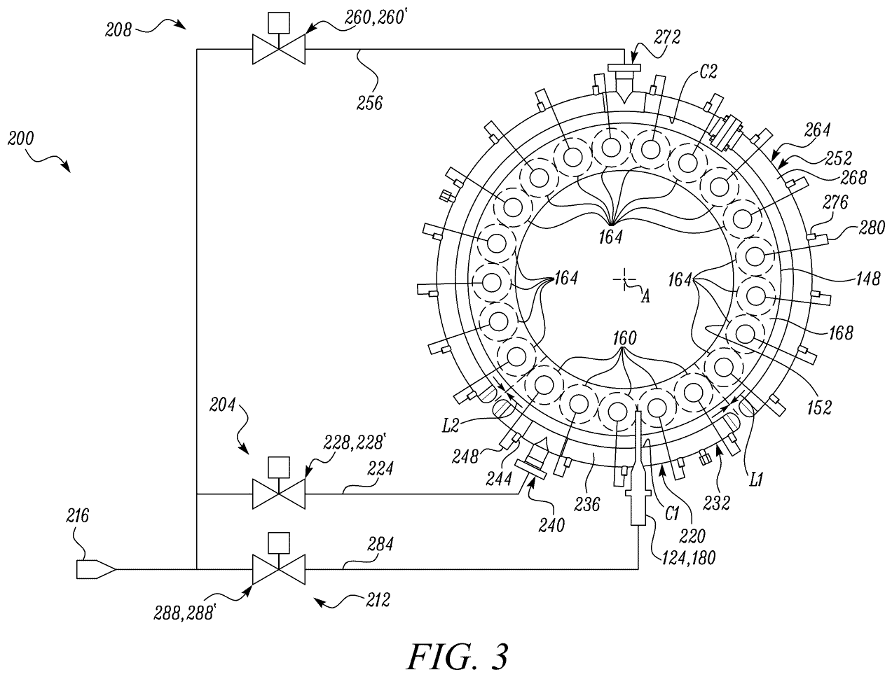

Further, the combustor 116 defines combustion zones, namely-one or more first zones 160 and one or more second zones 164. The first zones 160 and the second zones 164 may be defined within the annular cavity 156. The first zones 160 and the second zones 164 may be defined circumferentially about a central axis ‘A’ of the gas turbine engine 100, as shown in FIG. 3. The first zones 160 and the second zones 164 may be circumferentially defined such that the first zones 160 may be located relatively proximal to the ignition source 124 and the second zones 164 may be located relatively distal from the ignition source 124. In an example embodiment, as shown in FIG. 3, twenty-one combustion zones, including five first zones 160 and sixteen second zones 164, are defined in the annular cavity 156 of the combustor 116 in a manner such that the five first zones 160 are located relatively proximal to the ignition source 124 and the sixteen second zones 164 are located relatively distal from the ignition source 124. It should be noted that the number of combustion zones may vary depending on the type and/or power generating capacity of the gas turbine engines.

Although in the illustrated embodiment of FIG. 3, the first zones 160 are shown relatively proximal to the ignition source 124 and the second zones 164 are shown relatively distal from the ignition source 124, it should be noted that the first zones 160 and the second zones 164 may be defined (or arranged) in any known arrangement, for example, in a staggered arrangement along a circumference of a combustion chamber 168 of the combustor 116, about the central axis ‘A’. For instance, the first zones 160 and the second zones 164 may be evenly distributed along the circumference of the combustion chamber 168. In one example, at least one first zone 160 may be defined after every three consecutive second zones 164. In another example, at least one first zone 160 may be defined after every four consecutive second zones 164.

In one example configuration, as shown in FIG. 3, the combustor 116 may include a single annular combustion chamber 168 within which multiple combustion zones, i.e., the first zones 160 and the second zones 164, are defined in communication with each other. It should be contemplated that, in another example configuration, the combustor 116 may include multiple independent combustion chambers (separated by their respective walls), each of which may be configured to define a combustion zone such that the combustion zones from each of these combustion chambers are distinctly located from one another.

It should be noted that the configurations of the combustion zones (and/or the combustion chamber), whether contiguous or independent of each other in the gas turbine engine 100, as discussed above, are merely examples and do not limit the scope of the present disclosure. Embodiments of the present disclosure may be similarly applied to any configuration of combustion zones (and/or the combustion chamber) defined by suitable structures known to persons skilled in the art without deviating from the present disclosure.

The injectors 120 are circumferentially arranged about the combustor 116 and hence, configured to correspond with different combustion zones of the combustor 116. The injectors 120 include one or more first injectors 172 and one or more second injectors 176. The first injectors 172 may be positioned to communicate fuel (via injection) with their corresponding first zones 160 in the annular combustion chamber 168 of the combustor 116, whereas the second injectors 176 may be positioned to communicate fuel (via injection) with their corresponding second zones 164 in the annular combustion chamber 168 of the combustor 116. In an example embodiment, as shown in FIG. 3, twenty-one injectors 120, including five first injectors 172 and sixteen second injectors 176, are circumferentially arranged in the annular cavity 156 of the combustor 116.

It may be noted that although one fuel injector is shown to correspond with each combustion zone in the illustrated embodiment of FIG. 3, a number of fuel injectors disposed in communication with each combustion zone may vary as per the application requirements of the gas turbine engines. Accordingly, any number of injectors can be used with each of the given combustion zones in the combustor 116. For example, two or more fuel injectors may be positioned to inject fuel within a single combustion zone of the combustor 116.

The ignition source 124 may be configured to initiate a start-up sequence of the gas turbine engine 100, for example, by igniting a mixture of fuel and air supplied within the combustor 116. The ignition source 124 may also be fired periodically, or continually, to help stabilize the flame (e.g., keep it burning consistently and with consistent intensity). In an example embodiment, the ignition source 124 may include a torch igniter 180, mounted generally flush with a wall of the combustion chamber 168 (or the combustor casing 148). The torch igniter 180 may include a spark device (not shown) configured to ignite starter fuel (not shown), providing an ignition flame to initiate the combustion. In another embodiments, the ignition source 124 may include direct igniters such as, battery powered igniters (connected to any known battery power source). Further, it may be appreciated that the ignition sources discussed above are merely examples and do not limit the scope of the present disclosure.

Continuing with FIGS. 1, 2 and 3, a system 200 for delivering fuel to the gas turbine engine 100 is shown. The system 200 ensures safe starting of the gas turbine engine 100 on fuels having heating capacities relatively lower than that of the natural gas. In other words, the system 200 facilitates the gas turbine engine 100 to start and operate on a fuel that have much lower volumetric energy density than that of the natural gas, and that have lower flammability limit relatively lower than that of the natural gas. It should be noted that the “lower flammability limit” (also referred to as “lower detonation limit”) of a fuel may correspond to lowest concentration of said fuel that can ignite with air at a given temperature and pressure. In an example, the system 200 facilitates the gas turbine engine 100 to start and operate safely on hydrogen gas (or mixture thereof) that has a lower flammability limit of about 4.4%, by volume, of hydrogen gas in air.

The system 200 includes a start fuel circuit 204 and at least one main fuel circuit, i.e., a main fuel circuit 208. In addition, the system 200 includes a torch fuel circuit 212. Each of the start fuel circuit 204, the main fuel circuit 208, and the torch fuel circuit 212 is discussed in detail below.

The start fuel circuit 204 is discussed with reference to FIG. 3. The start fuel circuit 204 is configured to be fluidly coupled to one or more of the first injectors 172. The start fuel circuit 204 facilitates supply of the fuel to the first injectors 172, for example, from a fuel supply source 216 of the gas turbine engine 100. The start fuel circuit 204 facilitates supply of the fuel, at a predefined first flow rate, to the first injectors 172 to facilitate injection of a first quantity of the fuel by each of the first injectors 172 into their corresponding first zones 160 defined in the combustion chamber 168. The start fuel circuit 204 includes a start fuel manifold 220, a start fuel supply line 224, and a first flow control valve 228. It should be noted that the start fuel circuit 204 may include other known hydraulic components and/or devices, such as filters, reducers, and the like, however, such hydraulic components are not discussed, as they may be contemplated by someone of skill in the art.

The start fuel manifold 220 may include a first arcuate body 232. The first arcuate body 232 may define a first concavity ‘C1’. The first arcuate body 232 may have a closed cross-section shape, such as a circular cross-section shape, a square cross-section shape, an oval cross-section shape, a hexagonal cross-section shape, or any irregular cross-section shape. In an example, as shown in FIGS. 2 and 3, the first arcuate body 232 has a circular cross-section shape. The first arcuate body 232 may include outer walls 236 and a flow passage (not shown) surrounded by the outer walls 236.

Further, the start fuel manifold 220 may include an inlet port 240 for receiving fuel (from fuel supply source 216) into the start fuel manifold 220. The inlet port 240 may be in fluid communication with the flow passage to communicate the fuel, received from the fuel supply source 216, to the flow passage. Also, the start fuel manifold 220 may include multiple outlet ports 244, each of the outlet ports 244 fluidly coupled with its corresponding first injector 172, for example, via one or more first supply lines 248 fluidly coupled to pilot and main passages of the first injector 172, to facilitate supply of the fuel from the flow passage (of the start fuel manifold 220) to the first injector 172. In an example, as shown in FIG. 3, the start fuel manifold 220 defines five outlet ports 244, each fluidly coupled with its corresponding first injector 172 (of the five first injectors 172).

The start fuel manifold 220 may be mounted to the gas turbine engine 100 with respect to the combustor 116 such that the start fuel manifold 220 extends about a first circumferential segment (or length) ‘L1’ of the combustor 116. In an example, the first circumferential segment (or length) ‘L1’ may extend about one-third (or 120 degrees) of entire circumference of the combustion chamber 168 of the combustor 116. In another example, the first circumferential segment (or length) ‘L1’ may extend about one-fourth (or 90 degrees) of entire circumference of the combustion chamber 168 of the combustor 116. Further, the start fuel manifold 220 may be mounted to the gas turbine engine 100 such that the first concavity ‘C1’ of the start fuel manifold 220 may face towards the central axis ‘A’ of the gas turbine engine 100. It should be noted that the shape and size of the start fuel manifold 220 may vary based on the type and/or configuration of the gas turbine engine.

The start fuel supply line 224 may extend between the fuel supply source 216 and the start fuel manifold 220. The start fuel supply line 224 may be configured to fluidly connect the inlet port 240 of the start fuel manifold 220 with the fuel supply source 216 in a manner to communicate fuel, for example, at a plurality of pressures, to the start fuel manifold 220 from the fuel supply source 216.

The first flow control valve 228 may be a solenoid actuated valve 228″. Although a solenoid actuated valve 228′ is contemplated, other types of valves such as a hydraulically actuated valve, a pneumatically actuated valve etc., known in the art would also apply. The first flow control valve 228 may be disposed along the start fuel supply line 224. The first flow control valve 228 may be in fluid communication with the fuel supply source 216 and the start fuel manifold 220. Further, the first flow control valve 228 may be disposed downstream of the fuel supply source 216 and may be disposed upstream of the inlet port 240 of the start fuel manifold 220. It should be noted that the terms “downstream” and “upstream” are defined with respect to the flow of the fuel from the fuel supply source 216 towards the start fuel manifold 220.

The first flow control valve 228 may be configured to move between a plurality of positions to restrict or allow the fluid to pass therethrough at a plurality of different desired flow rates. For instance, the first flow control valve 228 may be configured to move to a first position (of the plurality of positions) to restrict flow of the fuel from the fuel supply source 216 towards the inlet port 240 and into the flow passage of the start fuel manifold 220. In another instance, the first flow control valve 228 may be configured to move to a second position (of the plurality of positions) to allow the fuel to flow towards the inlet port 240 (of the start fuel manifold 220) at the predefined first flow rate to facilitate injection of the first quantity of the fuel (by the first injectors 172) into each of the first zones 160 of the combustor 116.

The main fuel circuit 208 is now discussed with reference to FIG. 3. The main fuel circuit 208 is configured to be fluidly coupled to one or more of the second injectors 176. The main fuel circuit 208 facilitates supply of the fuel to the second injectors 176, for example, from the fuel supply source 216. The main fuel circuit 208 facilitates supply of the fuel, at a predefined second flow rate, to the second injectors 176 to facilitate injection of a second quantity of the fuel by each of the second injectors 176 into their corresponding second zones 164 defined in the combustion chamber 168. In an embodiment, the second quantity of fuel injected by each of the second injectors 176 in their corresponding second zones 164 may be equal to the first quantity of fuel injected by each of the first injectors 172 in their corresponding first zones 160. In another embodiment, the second quantity of fuel may be different from the first quantity of fuel.

The main fuel circuit 208 includes a main fuel manifold 252, a main fuel supply line 256, and a second flow control valve 260. It should be noted that the main fuel circuit 208 may include other known hydraulic components and/or devices, such as filters, reducers, and the like, however, such hydraulic components are not discussed, as they may be contemplated by someone of skill in the art.

The main fuel manifold 252 may include a second arcuate body 264. The second arcuate body 264 may define a second concavity ‘C2’. The second arcuate body 264 may have a closed cross-section shape, such as a circular cross-section shape, a square cross-section shape, an oval cross-section shape, a hexagonal cross-section shape, or any irregular cross-section shape. In an example, as shown in FIGS. 2 and 3, the second arcuate body 264 has a circular cross-section shape. The second arcuate body 264 may include outside walls 268 and a flow passageway (not shown) surrounded by the outside walls 268.

Further, the main fuel manifold 252 may include an inlet opening 272 for receiving fuel (from fuel supply source 216) into the main fuel manifold 252. The inlet opening 272 may be in fluid communication with the flow passageway to communicate the fuel, received from the fuel supply source 216, to the flow passageway. Also, the main fuel manifold 252 may include outlet openings 276, each fluidly coupled with its corresponding second injector 176, for example, via one or more second supply lines 280 fluidly coupled to pilot and main passages of the second injector 176, to facilitate supply of the fuel from the flow passageway (of the main fuel manifold 252) to the second injector 176. In an example, as shown in FIG. 3, the main fuel manifold 252 defines sixteen outlet openings 276, each fluidly coupled with its corresponding second injector 176 (of the sixteen second injectors 176) via the second supply line 280.

The main fuel manifold 252 may be mounted to the gas turbine engine 100 with respect to the combustor 116 such that the main fuel manifold 252 extends about a second circumferential segment (or length) ‘L2’ of the combustor 116. In an example, the second circumferential segment (or length) ‘L2’ may extend about two-third (or 240 degrees) of entire circumference of the combustion chamber 168 of the combustor 116. In another example, the second circumferential segment (or length) ‘L2’ may extend about three-fourth (or 270 degrees) of entire circumference of the combustion chamber 168 of the combustor 116. In an example embodiment, as shown in FIG. 3, the second circumferential segment ‘L2’ and the first circumferential segment ‘L1’ combinedly define (or surround) the circumference of the combustor 116 (or the combustion chamber 168). Further, the main fuel manifold 252 may be mounted to the gas turbine engine 100 such that the second concavity ‘C2’ of the main fuel manifold 252 may face towards the central axis ‘A’ of the gas turbine engine 100. It should be noted that the shape and size of the main fuel manifold 252 may vary based on the type and/or configuration of the gas turbine engine.

The main fuel supply line 256 is now discussed. The main fuel supply line 256 may extend between the fuel supply source 216 and the main fuel manifold 252. The main fuel supply line 256 may be configured to fluidly connect the inlet opening 272 of the main fuel manifold 252 with the fuel supply source 216 in a manner to communicate fuel, for example, at a plurality of pressures, to the main fuel manifold 252 from the fuel supply source 216.

The second flow control valve 260 is now discussed. The second flow control valve 260 may be a solenoid actuated valve 260′. Although a solenoid actuated valve 260′ is contemplated, other types of valves such as a hydraulically actuated valve, a pneumatically actuated valve etc., known in the art would also apply. The second flow control valve 260 may be disposed along the main fuel supply line 256. The second flow control valve 260 may be in fluid communication with the fuel supply source 216 and the inlet opening 272 of the main fuel manifold 252. Further, the second flow control valve 260 may be disposed downstream of the fuel supply source 216 and may be disposed upstream of the inlet opening 272 of the main fuel manifold 252. It should be noted that the terms “downstream” and “upstream” are defined with respect to the flow of the fuel from the fuel supply source 216 towards the main fuel manifold 252.

The second flow control valve 260 may be configured to move between a plurality of states to restrict or allow the fluid to pass therethrough at a plurality of different desired flow rates. For instance, the second flow control valve 260 may be configured to move to a first state (of the plurality of states) to restrict flow of the fuel from the fuel supply source 216 towards the inlet opening 272 and into flow passageway of the main fuel manifold 252. In another instance, the second flow control valve 260 may be configured to move to a second state (of the plurality of states) to allow the fuel to flow towards the inlet opening 272 (of the main fuel manifold 252), for example, at the predefined second flow rate to facilitate injection of the second quantity of the fuel (by the second injectors 176) into each of the second zones 164 of the combustor 116.

Referring to FIG. 3, the torch fuel circuit 212 is now discussed. The torch fuel circuit 212 may include a torch fuel supply line 284 and a third flow control valve 288. The torch fuel supply line 284 may extend between the fuel supply source 216 and the ignition source 124. The torch fuel supply line 284 may be configured to fluidly connect the ignition source 124 with the fuel supply source 216 in a manner to supply fuel (to be ignited) to the ignition source 124, for example, to initiate the start-up sequence of the gas turbine engine 100.

The third flow control valve 288 is now discussed. The third flow control valve 288 may be a solenoid actuated valve 288′. Although a solenoid actuated valve 288′ is contemplated, other types of valves such as a hydraulically actuated valve, a pneumatically actuated valve etc., known in the art would also apply. The third flow control valve 288 may be disposed along the torch fuel supply line 284. The third flow control valve 288 may be in fluid communication with the fuel supply source 216 and the ignition source 124. Further, the third flow control valve 288 may be disposed downstream of the fuel supply source 216 and may be disposed upstream of the ignition source 124. It should be noted that the terms “downstream” and “upstream” are defined with respect to the flow of the fuel from the fuel supply source 216 towards the ignition source 124.

The third flow control valve 288 may be configured to move between a plurality of positions to restrict or allow the fluid to pass therethrough and into the ignition source 124. For instance, the third flow control valve 288 may be configured to move to a first position (of the plurality of positions) to restrict flow of the fuel from the fuel supply source 216 to the ignition source 124. In another instance, the third flow control valve 288 may be configured to move to a second position (of the plurality of position) to allow the fuel to flow to the ignition source 124, for example, to facilitate ignition of the fuel for initiating the start-up sequence of the gas turbine engine 100.

It should be noted that the torch circuit 212 for supplying the fuel to the ignition source 124, i.e., torch igniter 180, (from the fuel supply source 216) as described herein is merely an example in nature and is not intended to limit the scope of the present disclosure. For instance, in some embodiments in which the torch igniter 180 is replaced with a battery powered igniter, the torch circuit 212 may not be required.

Additionally, in some embodiments, the system 200 may further include a pressure balancing line (not shown). The pressure balancing line may extend between the start fuel circuit 204 and the main fuel circuit 208 to connect the start fuel circuit 204 with the main fuel circuit 208. In an example, the pressure balancing line may connect the start fuel supply line 224 (of the start fuel circuit 204) with the main fuel supply line 256 (of the main fuel circuit 208). The pressure balancing line may include an isolation valve (not shown) configured to be actuated to move to its open position (from its closed position) in response to successful start-up of the gas turbine engine 100. Once moved to its open position, the isolation valve may allow for fuel pressure to balance between the start fuel circuit and the main fuel circuit.

### INDUSTRIAL APPLICABILITY

Gas turbine engines, such as the gas turbine engine 100, typically operates using conventional fuel (e.g., a natural gas fuel) to safely and efficiently produce, for example, about 1-5 MW (megawatts) of power or more. Users (or operators) of such gas turbine engines are switching the fuel supplied to the gas turbine engines from the conventional fuel (i.e., natural gas) to alternative fuels, such as hydrogen-based fuels or hydrocarbon-based fuels.

Such hydrogen-based fuels (or hydrocarbon-based fuel mixtures) has a much lower volumetric energy density than that of the natural gas. Due to this, higher volume of the hydrogen-based fuel (or mixture) may be required to be supplied to the gas turbine engine (e.g., the gas turbine engine 100) to maintain the same operational load (i.e., load generated via usage of the conventional natural gas in the gas turbine engine 100). As we increase the volume of such hydrogen-based fuel supplied to the gas turbine engine 100, the fuel-to-air ratio in the exhaust (of the gas turbine engine 100) may increase in the event of a flameout. Further, in case of hydrocarbon-based fuel mixture, as the amount of hydrogen blended with the natural gas is increased, the fuel-to-air ratio may exceed the lower detonation limit (or lower flammability limit) of the mixture in the event of a flameout. Because of such lower flammability (or detonation) limit, if such hydrogen-based fuel or mixture reaches ignition source or exceeds the auto ignition delay time, then a detonation reaction would occur where a pressure may exceed 400 PSI (pounds per square inch). To keep the fuel-to-air ratio below the lower detonation limit (or lower flammability limit) in the exhaust in the event of a flameout and to safely start and operate the gas turbine engines, such as the gas turbine engine 100, using alternative fuels (e.g., hydrogen-based fuels or the hydrocarbon-based fuels), the present disclosure provides the system 200.

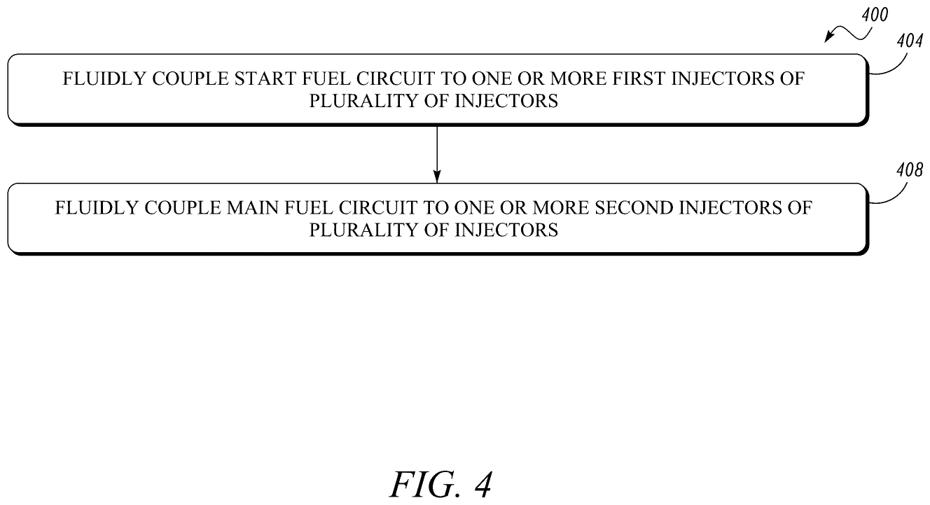

Referring to FIG. 4, an example method for delivering fuel, for example, fuel having volumetric energy density and lower flammability limit relatively lower than that of the natural gas, to the gas turbine engine 100, using the system 200 is now discussed. The method is discussed by way of a flowchart 400 that illustrates example steps (i.e., from 404 to 408) associated with the method. The example method is also discussed in conjunction with FIGS. 1-3.

Initially, the start fuel circuit 204 is fluidly coupled to the first injectors 172 of the plurality of injectors 120, at step 404. In this regard, the start fuel manifold 220 (of the start fuel circuit 204) may be retrofitted to the gas turbine engine 100, for example, via an operator of the gas turbine engine 100, such that the first concavity ‘C1’ of the start fuel manifold 220 faces towards the central axis ‘A’ of the gas turbine engine 100. Once retrofitted to the gas turbine engine 100, the start fuel manifold 220 covers the first circumferential segment ‘L1’ of the combustor 116. Subsequently, the outlet ports 244 of the start fuel manifold 220 are fluidly coupled with their corresponding first injectors 172, via the first supply lines 248. Once fluidly coupled with the first injectors 172, the start fuel circuit 204 may facilitate delivery of the fuel at the predefined first flow rate for injecting the first quantity of the fuel by each of the first injectors 172 into their corresponding first zones 160, for example, upon activation of the ignition source 124 of the gas turbine engine 100.

Next, the main fuel circuit 208 is fluidly coupled to the second injectors 176 of the plurality of injectors 120, at step 408. For instance, the main fuel manifold 252 (of the main fuel circuit 208) may be retrofitted to the gas turbine engine 100, for example, via the operator, such that the second concavity ‘C2’ of the main fuel manifold 252 faces towards the central axis ‘A’ of the gas turbine engine 100 and/or the start fuel manifold 220. Once retrofitted to the gas turbine engine 100, the main fuel manifold 252 covers the second circumferential segment ‘L2’ of the combustor 116, such that the second circumferential segment ‘L2’ and the first circumferential segment ‘L1’ combinedly surrounds the circumference of the combustor 116. Once fluidly coupled with the second injectors 176, the main fuel circuit 208 may facilitate delivery of the fuel at the predefined second flow rate for injecting the second quantity of the fuel by each of the second injectors 176 into their corresponding second zones 164, for example, in response to a light-off of the first quantity of the fuel injected in each first zone 160.

It should be noted that the disclosed method steps may be carried out in any technically feasible order and are not limited to the order described herein. For instance, although it is discussed in the above example method that the start fuel circuit 204 is fluidly coupled to the first injectors 172 prior to fluidly coupling the main fuel circuit 208 to the second injectors 176, it should be contemplated that, in another example method, the main fuel circuit 208 may be fluidly coupled to the second injectors 176 prior to fluidly coupling the start fuel circuit 204 to the first injectors 172.

Once the start fuel circuit 204 and the main fuel circuit 208 are fluidly coupled with the first injectors 172 and the second injectors 176, respectively, the operator may desire to start the gas turbine engine 100. In this regard, the operator may provide input to initiate the start-up sequence of the gas turbine engine 100. At this stage, the first flow control valve 228 is at its first position restricting the supply of fuel to the start fuel manifold 220, the second flow control valve 260 is at its first state restricting the supply of fuel to the main fuel manifold 252, and the third flow control valve 288 is at its first position restricting the supply of fuel to the ignition source 124.

In response to the input, the third flow control valve 288 is actuated from its first position to its second position to allow the fuel to flow from the fuel supply source 216 to the ignition source 124. At this stage, the first flow control valve 228 and the second flow control valve 260 remains at their respective first position and second state. Upon receipt of the fuel, the ignition source 124 may be activated to ignite the fuel to generate an ignition flame, and hence initiate the combustion within the combustion chamber 168.

As the ignition source 124 is activated to generate the ignition flame, the first flow control valve 228 is actuated from its first position to its second position to allow the fuel to flow towards the inlet port 240 (of the start fuel manifold 220) at the predefined first flow rate to facilitate injection of the first quantity of the fuel (by the first injectors 172) into each of the first zones 160 of the combustor 116. At this stage, the second flow control valve 260 remains at its first position to restrict any flow of fuel to the main fuel manifold 252 and into the second injectors 176. The first quantity of the fuel is injected while the injection of the second quantity of the fuel (by each the second injectors 176) is restricted to maintain a concentration of the fuel in a fuel-air mixture downstream of the combustor 116 below the lower flammability limit of the fuel. Because the first injectors 172 (and/or the first zones 160) are located relatively proximal to the ignition source 124, the first quantity of fuel injected by each of the first injectors 172 into their corresponding first zones 160 may be easily mixed with the compressed air and ignited by the ignition flame (generated by the ignition source 124).

Upon injection of the first quantity of fuel in each of the first zones 160, light-off of the first quantity of fuel may be detected. For clarity, it should be noted that throughout the following discussion, the term “light-off” refers to the development of a stable flame (e.g., a continuous flame) within the combustor 116. The light-off the first quantity of fuel may be detected upon determining (e.g., via thermocouples, flame detectors, etc.) a temperature of a fuel-air mixture downstream of the combustor 116. In an example, a successful light-off the first quantity of fuel may be verified if the temperature of the mixture of the first quantity of fuel and air equalizes or is above the predefined first threshold.

In response to the successful light-off of the first quantity of the fuel, the second flow control valve 260 is actuated from its first state to its second state to allow the fuel to flow towards the inlet opening 272 (of the main fuel manifold 252), for example, at the predefined second flow rate to facilitate injection of the second quantity of the fuel (by the second injectors 176) into each of the second zones 164 of the combustor 116. The second quantity of fuel injected by each of the second injectors 176 into their corresponding second zones 164 may be mixed with the compressed air and ignited by a starter flame (generated due to ignition of the first quantity of fuel in the first zones 160).

Upon injection of the second quantity of fuel in each of the second zones 164, light-off of the second quantity of fuel may be detected. The light-off the second quantity of fuel may be detected (or verified) upon determining (e.g., via thermocouples, flame detectors, etc.) the temperature of the fuel-air mixture downstream of the combustor 116 to be equal to or above a predefined second threshold. The predefined second threshold is higher than the predefined first threshold. Upon verifying the light-off of the second quantity of fuel, a successful start-up of the gas turbine engine 100 is acknowledged.

The disclosed system 200 for delivering the fuel may be applicable to any gas turbine engine where substitution of a conventional fuel (having higher volumetric energy density and lower flammability limit value, e.g., natural gas) with an alternative fuel (having relatively lower volumetric energy density and lower flammability limit value, e.g., hydrogen-based fuels) is desired. The disclosed system 200 may enable such conventional fuels to be switched with a hydrogen-based (or hydrocarbon-based) fuel without the need for redesigning the gas turbine engine to use the hydrogen-based (or hydrocarbon-based) fuel. Further, by limiting the supply of the hydrogen-based (or hydrocarbon-based) fuel into the combustor 116 via limited number of injectors 120 (i.e., via only five first injectors 172) during the start-up sequence of the gas turbine engine 100, the system 200 successfully maintains the concentration of the fuel in a fuel-air mixture downstream of the combustor below the lower flammability limit of the fuel, thereby minimizing the risk of explosion in the gas turbine engine 100.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the system, the gas turbine engine, and/or the method of the present disclosure without departing from the scope of the disclosure. Other embodiments will be apparent to those skilled in the art from consideration of the specification and practice of the system, the gas turbine engine, and/or the method disclosed herein. It is intended that the specification and examples be considered as example only, with a true scope of the disclosure being indicated by the following claims and their equivalent.

1. A system for delivering a fuel to a gas turbine engine, the gas turbine engine having a combustor and a plurality of injectors circumferentially arranged about the combustor, the system comprising:
a start fuel circuit configured to be fluidly coupled to one or more first injectors of the plurality of injectors to facilitate injection of a first quantity of the fuel by the one or more first injectors into one or more first zones of the combustor upon activation of an ignition source of the gas turbine engine;
at least one main fuel circuit configured to be fluidly coupled to one or more second injectors of the plurality of injectors to facilitate injection of a second quantity of the fuel by the one or more second injectors into one or more second zones of the combustor in response to a light-off of the first quantity of the fuel, and
at least one torch fuel circuit configured to be fluidly coupled to the ignition source of the gas turbine engine.

2. The system of claim 1, wherein the one or more first zones are located relatively proximal to the ignition source and the one or more second zones are located relatively distal from the ignition source.

3. The system of claim 1, wherein the start fuel circuit includes:
a start fuel manifold including an inlet port for receiving the fuel into the start fuel manifold and one or more outlet ports for correspondingly supplying the fuel to the one or more first injectors from the start fuel manifold; and
a first flow control valve fluidly coupled to the inlet port, the first flow control valve configured to move between a plurality of positions including a first position and a second position, wherein:
at the first position, the fuel is restricted to flow towards the inlet port and into the start fuel manifold, and
at the second position, the fuel is received into the start fuel manifold by the inlet port at a predefined first flow rate to facilitate the injection of the first quantity of the fuel into the one or more first zones of the combustor.

4. The system of claim 3, wherein the at least one main fuel circuit includes:
a main fuel manifold including an inlet opening for receiving the fuel into the main fuel manifold and one or more outlet openings for correspondingly supplying the fuel to the one or more second injectors from the main fuel manifold; and
a second flow control valve fluidly coupled to the inlet opening, the second flow control valve configured to move between a plurality of states including a first state and a second state, wherein:
at the first state, the fuel is restricted to flow towards the inlet opening and into the main fuel manifold, and
at the second state, the fuel is received into the main fuel manifold by the inlet opening at a predefined second flow rate to facilitate the injection of the second quantity of the fuel into the one or more second zones of the combustor.

5. The system of claim 4, wherein the start fuel manifold includes a first arcuate body extending along a first circumferential segment of the combustor and the main fuel manifold includes a second arcuate body extending along a second circumferential segment of the combustor, and wherein the first circumferential segment and the second circumferential segment combinedly defines a circumference of the combustor.

6. The system of claim 1, wherein the fuel has a lower flammability limit relatively lower than a lower flammability limit of a natural gas.

7. The system of claim 1, wherein the first quantity of the fuel is injected upon the activation of the ignition source while the injection of the second quantity of the fuel is restricted to maintain a concentration of the fuel in a fuel-air mixture downstream of the combustor below a lower flammability limit of the fuel, and
wherein the start fuel circuit is connected to a first flow control valve, the at least one main fuel circuit is connected to a second flow control valve, and the torch fuel circuit is connected to a third flow control valve.

8. The system of claim 1, wherein the fuel is a hydrogen-based fuel or a hydrocarbon-based fuel.

9. A gas turbine engine comprising:
a combustor defining one or more first zones and one or more second zones;
an ignition source configured to initiate a start-up sequence of the gas turbine engine;
a plurality of injectors circumferentially arranged about the combustor, the plurality of injectors including one or more first injectors and one or more second injectors; and
a system for delivering a fuel, the system including:
a start fuel circuit configured to be fluidly coupled to the one or more first injectors to facilitate injection of a first quantity of the fuel by the one or more first injectors into the one or more first zones upon activation of the ignition source;
at least one main fuel circuit configured to be fluidly coupled to the one or more second injectors to facilitate injection of a second quantity of the fuel by the one or more second injectors into the one or more second zones in response to a light-off of the first quantity of the fuel, and
at least one torch fuel circuit configured to be fluidly coupled to the ignition source of the gas turbine engine.

10. The gas turbine engine of claim 9, wherein the one or more first zones are located relatively proximal to the ignition source and the one or more second zones are located relatively distal from the ignition source.

11. The gas turbine engine of claim 9, wherein the start fuel circuit includes:
a start fuel manifold including an inlet port for receiving the fuel into the start fuel manifold and one or more outlet ports for correspondingly supplying the fuel to the one or more first injectors from the start fuel manifold; and
a first flow control valve fluidly coupled to the inlet port, the first flow control valve configured to move between a plurality of positions including a first position and a second position, wherein:
at the first position, the fuel is restricted to flow towards the inlet port and into the start fuel manifold, and
at the second position, the fuel is received into the start fuel manifold by the inlet port at a predefined first flow rate to facilitate the injection of the first quantity of the fuel into the one or more first zones of the combustor.

12. The gas turbine engine of claim 11, wherein the at least one main fuel circuit includes:
a main fuel manifold including an inlet opening for receiving the fuel into the main fuel manifold and one or more outlet openings for correspondingly supplying the fuel to the one or more second injectors from the main fuel manifold; and
a second flow control valve fluidly coupled to the inlet opening, the second flow control valve configured to move between a plurality of states including a first state and a second state, wherein:
at the first state, the fuel is restricted to flow towards the inlet opening and into the main fuel manifold, and
at the second state, the fuel is received into the main fuel manifold by the inlet opening at a predefined second flow rate to facilitate the injection of the second quantity of the fuel into the one or more second zones of the combustor.

13. The gas turbine engine of claim 12, wherein the start fuel manifold includes a first arcuate body extending along a first circumferential segment of the combustor and the main fuel manifold includes a second arcuate body extending along a second circumferential segment of the combustor, and wherein the first circumferential segment and the second circumferential segment combinedly defines a circumference of the combustor.

14. The gas turbine engine of claim 9, wherein the fuel has a lower flammability limit relatively lower than a lower flammability limit of a natural gas, and
wherein the first quantity of the fuel is injected upon the activation of the ignition source while the injection of the second quantity of the fuel is restricted to maintain a concentration of the fuel in a fuel-air mixture downstream of the combustor below the lower flammability limit of the fuel, and
wherein the start fuel circuit is connected to a first flow control valve, the main fuel circuit is connected to a second flow control valve, and the torch fuel circuit is connected to a third flow valve.

15-20. (canceled)

21. The system of claim 1, wherein the start fuel circuit is connected to a first flow control valve, the main fuel circuit is connected to a second flow control valve, and the torch fuel circuit is connected to a third flow control valve.

22. The gas turbine engine of claim 9, wherein the start fuel circuit is connected to a first flow control valve, the main fuel circuit is connected to a second flow control valve, and the torch fuel circuit is connected to a third flow control valve.

23. A system for delivering a fuel to a gas turbine engine, the gas turbine engine having a combustor and a plurality of injectors circumferentially arranged about the combustor, the system comprising:
a first fuel circuit configured to be fluidly coupled to one or more first injectors of the plurality of injectors to facilitate injection of a first quantity of the fuel by the one or more first injectors into one or more first zones of the combustor upon activation of an ignition source of the gas turbine engine;
a second fuel circuit configured to be fluidly coupled to one or more second injectors of the plurality of injectors to facilitate injection of a second quantity of the fuel by the one or more second injectors into one or more second zones of the combustor in response to a light-off of the first quantity of the fuel; and
a third fuel circuit configured to be fluidly coupled to the ignition source of the gas turbine engine,
wherein the first fuel circuit is connected to a first flow control valve, the second fuel circuit is connected to a second flow control valve, and the third fuel circuit is connected to a third flow control valve.

24. The system of claim 23, wherein the one or more first zones are located relatively proximal to the ignition source and the one or more second zones are located relatively distal from the ignition source.

25. The system of claim 23, wherein the first fuel circuit includes:
a first fuel manifold including an inlet port for receiving the fuel into the first fuel manifold and one or more outlet ports for correspondingly supplying the fuel to the one or more first injectors from the first fuel manifold, and
wherein the first flow control valve is configured to move between a plurality of positions including a first position and a second position, wherein:
at the first position, the fuel is restricted to flow towards the inlet port and into the first fuel manifold, and
at the second position, the fuel is received into the first fuel manifold by the inlet port at a predefined first flow rate to facilitate the injection of the first quantity of the fuel into the one or more first zones of the combustor.

26. The system of claim 25, wherein the second fuel circuit includes
a second fuel manifold including an inlet opening for receiving the fuel into the second fuel manifold and one or more outlet openings for correspondingly supplying the fuel to the one or more second injectors from the second fuel manifold; and
wherein the second flow control valve configured to move between a plurality of states including a first state and a second state, wherein:
at the first state, the fuel is restricted to flow towards the inlet opening and into the second fuel manifold, and
at the second state, the fuel is received into the second fuel manifold by the inlet opening at a predefined second flow rate to facilitate the injection of the second quantity of the fuel into the one or more second zones of the combustor.
